(19) United States
(12) Patent Application Publication
(10) Pub. No.: US 2004/0247495 A1
(43) Pub. Date: Dec. 9, 2004

(54) Mobile photocatalytic air cleaner

(76) Inventor: Hsi Cheng Huang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/453,493

(22) Filed: Jun. 4, 2003

(51) Int. Cl. B01J 19/08; B01J 19/12

(52) U.S. Cl. 422/186

(57) ABSTRACT

A mobile photocatalytic air cleaner is constructed to includes a metal casing mountable in one expansion slot of a PC (personal computer), ultraviolet lamps mounted in the casing, a photocatalyst-coated air filter structure provided around the ultraviolet lamps inside the casing, and fans adapted to draw outside air into the inside of the PC through the photocatalyst-coated air filter structure and the ultraviolet lamps.

### BACKGROUND OF THE INVENTION

1. Field of the Invention

The present invention relates to an air cleaner and, more particularly, to a mobile photocatalytic air cleaner, which is mountable in an expansion slot of a PC for drawing air through the PC and sterilizing the air.

2. Description of the Related Art

Conventional air cleaners are independent apparatus using a draft regulating device and an air filter device to purify the air. There are known some air cleaners employing photocatalytic technology to clean the air. These conventional independent air cleaners are commonly complicated and expensive. There are also known mobile air cleaners designed for use in personal computers. These mobile air cleaners can be installed in the expansion slots of personal computers. However, because these mobile air cleaners simply use active carbon and wire gauge filters to remove solid matters from the air, they cannot sterilize the air.

### SUMMARY OF THE INVENTION

The present invention has been accomplished under the circumstances in view. It is therefore the main object of the present invention to provide a mobile photocatalytic air cleaner, which is mountable in an expansion slot of a personal computer to clean the air passing through the personal computer. It is another object of the present invention to provide a mobile photocatalytic air cleaner, which effectively sterilizes the air when removing solid matters from the air. It is still another object of the present invention to provide a mobile photocatalytic air cleaner, which is inexpensive to manufacture. To achieve these and other objects of the present invention, the mobile photocatalytic air cleaner comprises a metal casing mountable in one expansion slot of a PC (personal computer), ultraviolet lamps mounted in the casing, a photocatalyst-coated air filter structure provided around the ultraviolet lamps inside the casing, and fans adapted to draw outside air into the inside of the PC through the photocatalyst-coated air filter structure and the ultraviolet lamps.

### BRIEF DESCRIPTION OF THE DRAWINGS

FIG. 1 is an exploded view of a part of a mobile photocatalytic air cleaner according to the present invention.

FIG. 2 is an exploded view of an open frame and an air filter material for use in the mobile photocatalytic air cleaner according to the present invention.

FIG. 3 is a sectional view in an enlarged scale of the air filter material shown in FIG. 2.

FIG. 4 is another exploded view of a part of the mobile photocatalytic air cleaner according to the present invention.

FIG. 5 is an assembly view of FIG. 4.

FIG. 6 is an elevational view of a top cover for the mobile photocatalytic air cleaner according to the present invention.

FIG. 7 is an elevational view showing the outer appearance of the mobile photocatalytic air cleaner according to the present invention.

FIG. 8 is an elevational view of an alternate form of the mobile photocatalytic air cleaner according to the present invention.

FIG. 9 is an applied view of the present invention, showing the mobile photocatalytic air cleaner installed in the mainframe of a personal computer.

### DETAILED DESCRIPTION OF THE PREFERRED EMBODIMENT

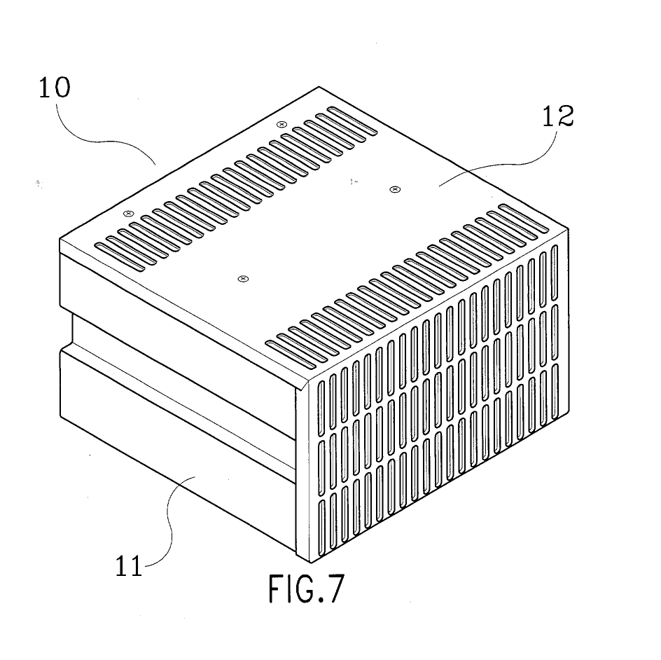

Referring to FIG. 7, a mobile photocatalytic air cleaner 10 in accordance with the present invention is shown comprised of a metal casing 11 and a top cover 12, and adaptable to mount in an expansion slot of the mainframe of a personal computer.

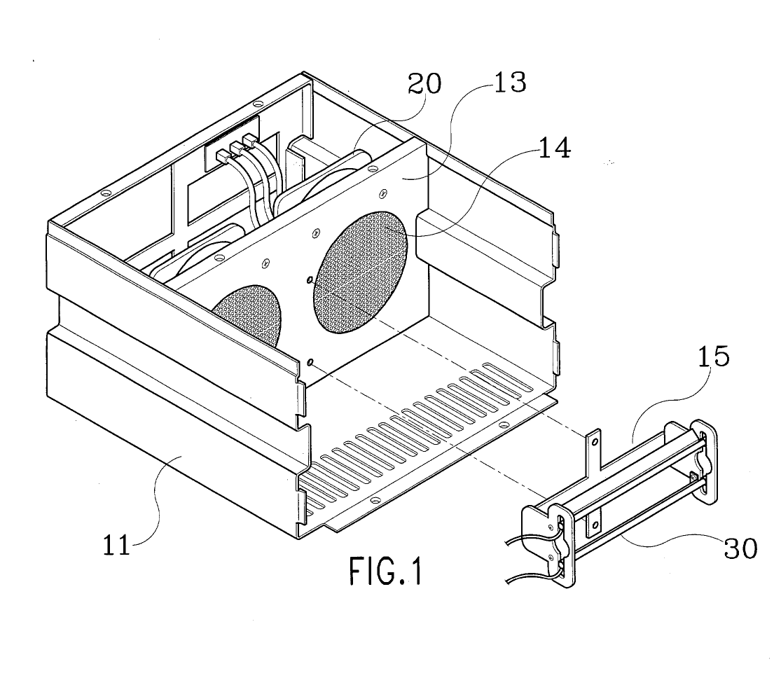

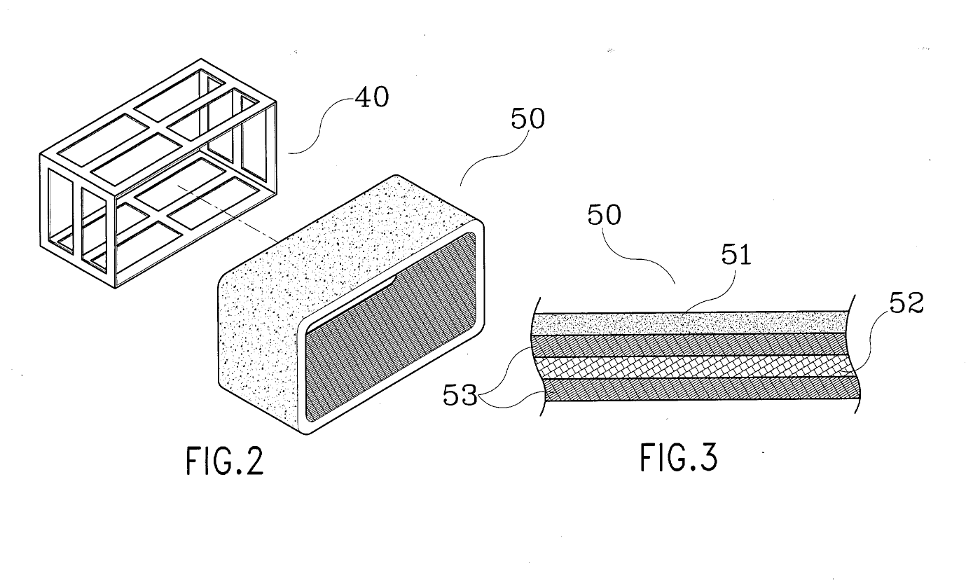

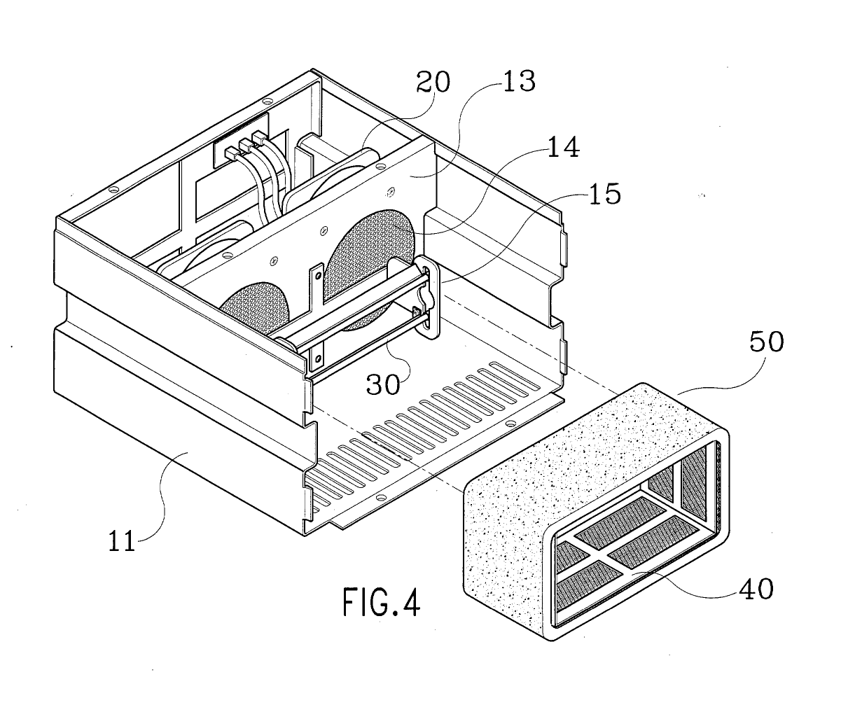

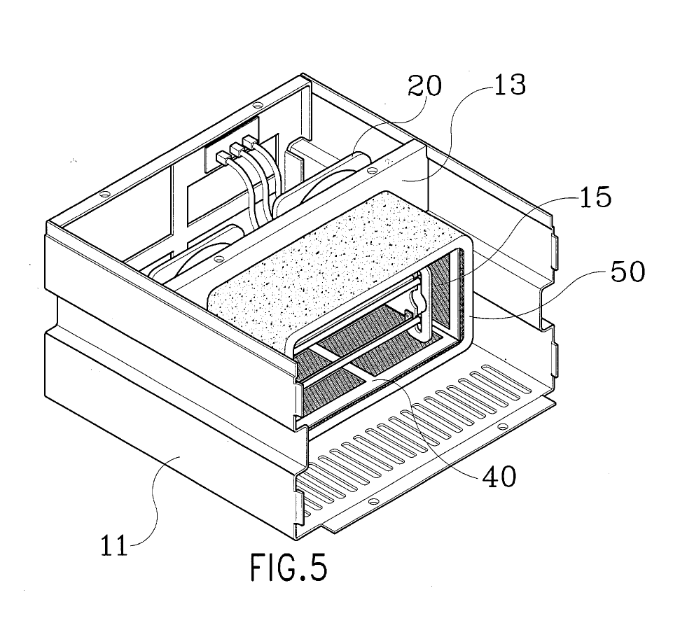

Referring to FIGS. 1˜5 and FIG. 7 again, the metal casing 11 has a metal partition plate 13 transversely located on the middle. The metal partition plate 13 divides the holding space of the casing 11 into two parts, namely, the front inside space and the rear inside space. The metal partition plate 13 has two air vents 14 in communication between the front inside space and rear inside space of the holding space of the casing 11. Two fans 20 are mounted in the rear inside space of the holding space of the casing 11 and respectively aimed at the air vents 14. A metal lamp rack 15 is mounted inside the front inside space of the holding space of the casing 11 adjacent to the metal partition plate 13 to hold a pair of ultraviolet lamps 30. An air filter material 50 is carried on the periphery of a metal open frame 40, and mounted with the metal open frame 40 inside the front inside space of the holding space of the casing 11 around the lamp rack 15 and the ultraviolet lamps 30 (see FIGS. 4 and 5). The metal open frame 40 prohibits direct contact between the ultraviolet lamps 30 and the air filter material 50. The air filter material 50 comprises two glass fiber layers 53, a layer of plastic netting 52 sandwiched in between the glass fiber layers 53, and an active carbon layer 51 covered on the outer surface of one glass fiber layer 53 (see FIG. 3). When the air filter material 50 mounted on the periphery of the metal open frame 40, the active carbon layer 51 is exposed to the outside and kept away from the metal open frame 40. Further, the air filter material 50 is peripherally coated with a layer of photocatalyst, for example, titanium dioxide.

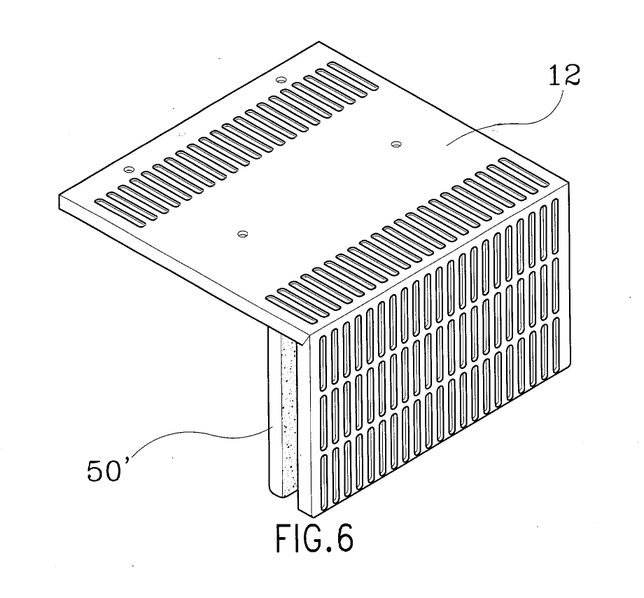

Referring to FIGS. 6 and 7, the top cover 12 is covered on the casing 11 to keep the internal structure of the photocatalytic air cleaner from sight. The top cover 12 is a slotted cover plate that admits air. Further, the top cover 12 has an air filter material 50′ vertically disposed on the inside. The structure of the air filter material 50′ is same as the air filter material 50 (see also FIGS. 3 and 4). When the top cover 12 covered on the casing 11, the air filter material 50′ is attached to the front open side of the metal open frame 40. Therefore, when the mobile photocatalytic air cleaner 10 assembled (see FIG. 7), the air filter materials 50 and 50′ surround the ultraviolet lamps 30.

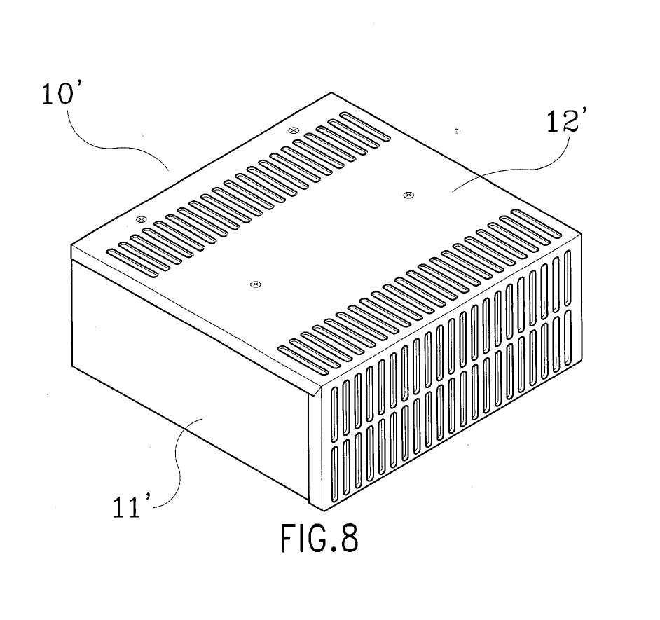

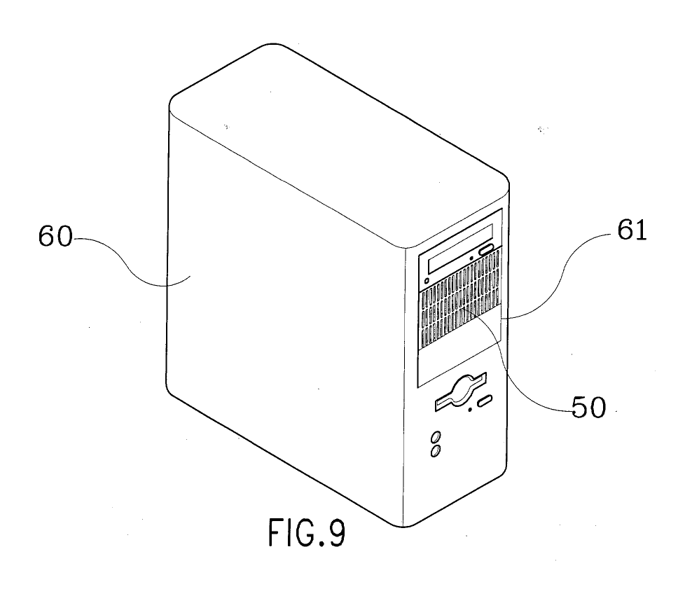

Referring to FIG. 9, the mobile photocatalytic air cleaner 10 can be installed in the space for expansion slots 61 in the mainframe 60 of a personal computer. The size of the mobile photocatalytic air cleaner 10 fits two expansion slots. FIG. 8 shows a compact mobile photocatalytic air cleaner 10′ constructed according to the present invention. According to this alternate form, the mobile photocatalytic air cleaner 10′ fits one expansion slot in the mainframe of a personal computer. During the operation of the personal computer, the fans 20 draw outside fresh air into the inside of the personal computer through the air vents 14. When air passing through the air vents 14, the ultraviolet rays from the ultraviolet lamps 30 sterilize the flowing currents of air and, the photocatalytic effect of the photocatalyst in the air filter materials 50 and 50′ deodorizes the flowing currents of air (see FIG. 5). Further, the sterilized and deodorized currents of air carry heat away from the personal computer when circulating through the personal computer.

As indicated above, the mobile photocatalytic air cleaner can be made in two different sizes for use subject to the condition of the room space in which the personal computer is installed.

A prototype of mobile photocatalytic air cleaner has been constructed with the features of FIGS. 1˜9. The photocatalytic air cleaner functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mobile photocatalytic air cleaner comprising.
a metal casing mountable in the space for expansion slots of the mainframe of a personal computer, said metal casing having a metal partition plate transversely located on the inside and dividing the holding space of said metal casing into a front inside space and a rear inside space, said metal partition plate having at least one air vent in communication between said front inside space and said rear inside space;
fan means mounted in the rear inside space of said metal casing and adapted to draw air through said metal casing in direction from the inside of said metal casing toward the rear inside space of said metal casing;
a lamp rack mounted in the front inside space of said metal casing, said lamp rack holding at least one ultraviolet lamp;
a metal open frame mounted in the front inside space of said metal casing around said lamp rack;
an air filter material coated with a layer of photocatalyst and covering the peripheral and a front side of said metal open frame; and
a top cover covering said metal casing.

2. The mobile photocatalytic air cleaner as claimed in claim 1, wherein said air filter material comprises two glass fiber layers, a layer of plastic netting sandwiched in between said glass fiber layers, an active carbon layer covered on an outer surface of one of said glass fiber layers, and said photocatalyst coated on said active carbon layer.
